(19) United States
(12) Patent Application Publication
(10) Pub. No.: US 2013/0258890 A1
(43) Pub. Date: Oct. 3, 2013

(54) WIRELESS COMMUNICATION METHOD FOR MONITORING A COMMUNICATION INTERFACE BETWEEN ACCESS NODES

(71) Applicant: FUJITSU LIMITED, Kawasaki-shi (JP)

(72) Inventors: Zhaojun LI, Guildford Surrey (GB); Paul BUCKNELL, Brighton (GB); Sunil Keshavji VADGAMA, Ashford Middlesex (GB)

(21) Appl. No.: 13/898,561

(22) Filed: May 21, 2013

Related U.S. Application Data
(63) Continuation of application No. PCT/EP2010/070527, filed on Dec. 22, 2010.

(51) Int. Cl. H04W 24/02

(52) U.S. Cl. CPC H04W 24/02
USPC 370/252

(57) ABSTRACT

A wireless communication method and a wireless communication system includes a user equipment and a cooperating set of access nodes, each access node being operable to wirelessly exchange data and/or signalling information with the user equipment, the cooperating set participating directly or indirectly in the exchange with the user equipment in accordance with an exchange scheme, the cooperating set includes at least a first access node, the first access node being interconnected by an interface with a second access node.

This application is a continuation application based on international application number PCT/EP2010/070527, filed on Dec. 22, 2010, the entire contents of which are incorporated herein by reference.

The present invention relates to a wireless communication method in a wireless communication system, said wireless communication system comprising a plurality of access nodes and a user equipment, each of the access nodes being operable to wirelessly exchange data and/or signalling information with said user equipment, said plurality of access nodes comprising at least a first access node and a second access node, said first and second access nodes being interconnected by a, wireless or wired, interface. The present invention further relates to an access node, a user equipment, and a wireless communication method being operable to carrying out said wireless communication method. Particularly, but not exclusively, the present invention relates to a wireless communication method compliant with the LTE (Long Term Evolution) and LTE-Advanced radio technology groups of standards as, for example, described in the 36-series (in particular, specification documents 36.xxx and documents related thereto) and releases 9, 10 and subsequent of the 3GPP specification series.

Universal Mobile Telecommunications System (UMTS) or 3G wireless communication systems are deployed worldwide. Future development of UMTS systems is centred on the LTE and LTE-Advanced radio technology. 3GPP is defining specifications for advanced functions and features for LTE known as the LTE-Advanced standard. Coordinated multi-point (CoMP) transmission/reception is one such feature of the LTE-Advanced and future developments of LTE-Advanced. CoMP can improve the coverage of high data rates, the cell-edge throughput and/or to increase system throughput in both high load and low load scenarios.

Next generation mobile communications such as UMTS and UMTS LTE aim to offer improved services to the user compared to the existing systems. These systems are expected to offer high data rate services for the processing and transmission of a wide range of information, such as voice, video and IP multimedia data.

LTE is a technology for the delivery of high speed data services with increased data rates for the users. Compared to UMTS and previous generations of mobile communication systems, LTE will also offer reduced delays, increased cell edge coverage, reduced cost per bit, flexible spectrum usage and multi-radio access technology mobility.

The Evolved UTRAN is an evolution of the 3G UMTS radio-access network UTRAN towards a high-data-rate, low-latency and packet-optimized radio-access network in the LTE and LTE-Advanced technology. The E-UTRAN architecture is described, for example, in 3GPP TR 36.401, in particular section 6, the disclosure thereof is hereby incorporated by reference in the present application.

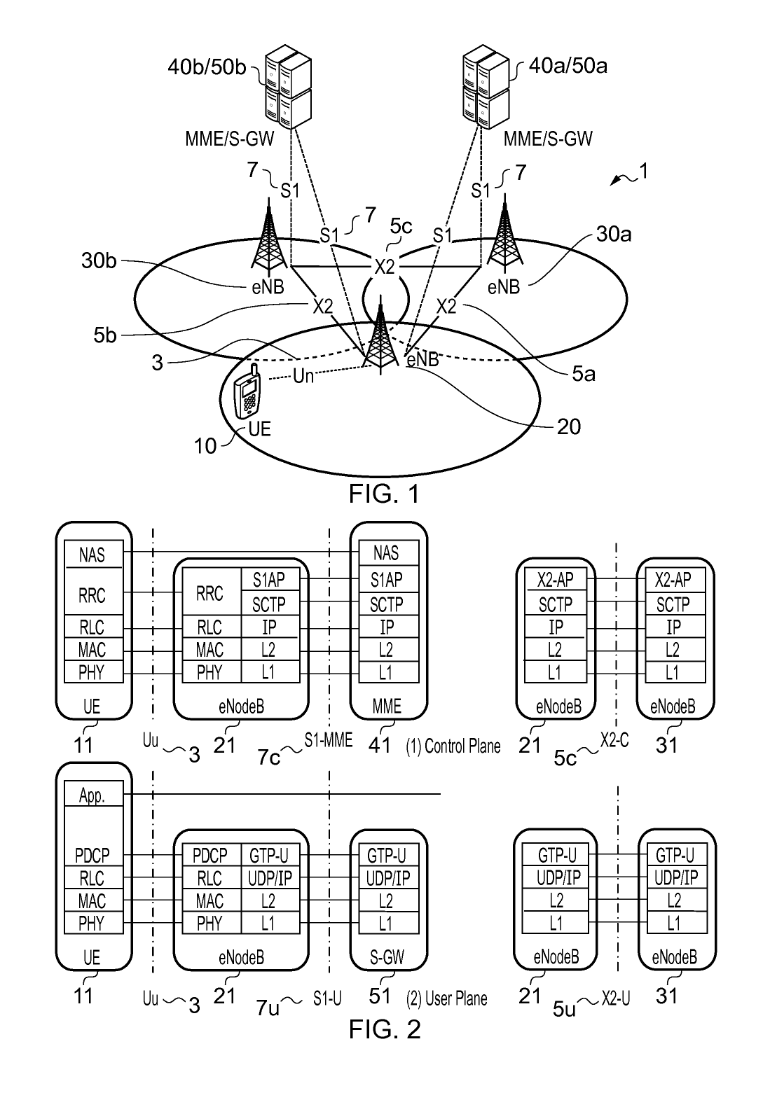

As in current UMTS systems, the basic architecture of LTE (and, consequently, of LTE-Advanced) consists of a radio access network (the E-UTRAN) connecting users (or, more precisely, user equipments, UEs) to access nodes (E-UTRAN Nodes B, eNBs) acting as base stations, these access nodes in turn being linked to a core network (the Evolved Packet Core, EPC). The eNBs provide E-UTRA (Evolved Universal Terrestrial Radio Access) user plane and control plane protocol terminations towards the UEs. The eNBs (the term “eNB” is interchangeably used with the term “access node” in the present application) may be interconnected with each other by means of a X2 interface. The eNBs are connected by means of a S1 interface to the EPC, more specifically to the MME by means of a S1-MME and to the S-GW by means of a S1-U. The S1 interface supports a many-to-many relation between MMEs/Serving Gateways and eNBs. A typical E-UTRAN architecture is illustrated in FIG. 1 as explained above.

Further details of the E-UTRAN radio interface protocol architecture are described, for example, in 3GPP TR 36.300; the disclosure thereof being hereby incorporated by reference in the present application.

An eNB may support FDD mode, TDD mode or dual mode operation. eNBs may be interconnected through the X2. The X2 may be a logical interface between two eNBs. Whilst logically representing a point to point link between eNBs, the physical realization needs not be a point to point link. The X2 interface is described in more detail, for example, in specification series 3GPP TS 36.42x; the disclosure thereof being hereby incorporated by reference in the present application.

LTE has been designed to give peak data rates in the downlink (DL) (communication from a base station (BS) to a user equipment (UE) of, for example, >100 Mbps whilst in the uplink (UL) (communication from the UE to the BS)>50 Mbps. LTE-Advanced (LTE-A) currently being standardised will further improve the LTE system to allow, for example, up to 1 Gbps in the downlink and 500 Mbps in the uplink. LTE-A will use new techniques to improve the performance over existing LTE systems, particular for the transmission of higher data rates and improvements to cell edge coverage.

A typical LTE network is shown in FIG. 1. A UE 10 is connected to an eNB 20 (also referred to as “access node”) by the radio interface Uu 3.

eNBs 20, 30 are connected via a S1 interface 7 to a core network (CN, not explicitly illustrated). eNBs 20, 30 are connected to the Mobility Management Entities (MMES) 40a, 40b via a S1 control plane interface (S1-MME), which provides the control functions for, for example, Idle mode UE reachability and Active mode UE handover support. The User Plane (UP) data for the UE 10 is routed via the eNBs 20, 30 to a Serving Gateway (S-GW) 50a, 50b via a S1 user plane interface (S1-U) interface.

The eNBs 20, 30 may be interconnected by X2 interfaces 5a, 5b, 5c, which may be implemented as a physical connection between two eNBs 20, 30 or as a logical connection routed via other network transport nodes. The X2 interface 5 as the communication interface between eNBs 20, 30 as well as the S1 interface 7 between eNB 20, 30 and MME/S-GW 40, 50 are referred to as a backhaul link.

FIG. 2 illustrates protocol stacks for the control and user planes in an architecture as illustrated in FIG. 1.

Over the radio interface Uu 3 between the UE 11 and the eNB 21 (also referred to as “eNodeB”), user data traffic is transported using the User-Plane (that consists, for example, of PDCP, RLC, MAC and PHY protocol layers). The S1-U interface 7u is defined between the eNB 21 and the S-GW 51. The S1-U interface 7u provides non guaranteed delivery of user plane PDUs (protocol data units) between the eNB 21 and the S-GW 51. The transport network layer is built on IP transport and GTP-U (GPRS Tunnelling Protocol for User Plane) is used on top of UDP (User Datagram Protocol)/IP to carry the user plane PDUs between the eNB 21 and the S-GW 51.

The S1-MME interface 7c is defined between the eNB 21 and the MME 41. The transport network layer is built on IP transport, similarly to the user plane, but for the reliable transport of signalling messages SCTP (Stream Control Transmission Protocol, which is a reliable transport layer protocol defined by the Internet Engineering Task Force (IETF)) is added on top of IP. The application layer signalling protocol is referred to as S1-AP (S1 Application Protocol).

An X2 user plane interface (X2-U) 5u is defined between eNBs 21, 31. The X2-U interface 5u provides non guaranteed delivery of user plane PDUs. The transport network layer is built on IP transport and GTP-U is used on top of UDP/IP to carry the user plane PDUs. The X2-U (X2-user plane) interface protocol stack is identical to the S1-UP (S1-user plane) protocol stack.

An X2 control plane interface (X2-C) 5c is defined between two neighbour eNBs 21, 31. The transport network layer is built on SCTP on top of IP. The application layer signalling (information) protocol is referred to as X2-AP (X2 Application Protocol).

In 3GPP LTE network, eNBs may be interconnected with each other by means of the X2 interface as a full mesh or part of a full mesh within the E-UTRAN (Evolved UTRAN (Universal Terrestrial Radio Access Network)). Information exchange can be carried out between eNBs via the X2 interface in the flat architecture used in LTE.

However, the X2 interfaces differ between different operators and network deployment solutions. Thus, access networks (in particular X2 links) may operate non-uniformly and, hence, provide unreliable or delayed communication. It is however desirable to provide reliable and un-delayed communication within a wireless communication network.

According to one aspect of the present invention, a wireless communication method in a wireless communication system is provided, said wireless communication system comprising a plurality of access nodes and a user equipment, each of the access nodes being operable to wirelessly exchange data and/or signalling information with said user equipment, said plurality of access nodes comprising at least a first access node and a second access node, said first and second access nodes being interconnected by an interface, said wireless communication method comprising:
communicating between said first and second access nodes via said interface,
monitoring a parameter relating to said communication between said first and second access nodes via said interface, and
controlling said exchange of data and/or signalling information between said first and/or second access nodes and said user equipment in dependence upon said monitored parameter.

The inventors of the present application surprisingly found that by measuring an backhaul link performance, preferably the interface performance, and by controlling the exchange of data and/or signalling information between the first and/or second access nodes and said user equipment accordingly, wireless communication within a wireless communication system is improved. The backhaul link may be wired or wireless.

The wireless communication method may be applied, for example, in interference co-ordination (whereby information is exchanged in order to minimise interference) between access nodes, broadcasting of data, handover of UEs, or coordinated multi-point (CoMP) transmission/reception. The information exchanged over X2 may include, for example, 1) load or interference related information; 2) handover related information. The exchange frequency may be rather low, for example the frequency of load information exchange for X2 load balancing process may be in the order of seconds. The exchange frequency also may be rather high, for example the frequency of load information exchange for RRM optimization (such as interference coordination) may in the order of tens of milliseconds.

The interference co-ordination between access nodes, broadcasting of data, the handover of UEs, or the coordinated multi-point (CoMP) transmission/reception are just examples for using the concept of measuring the backhaul performance and controlling the operation of the wireless communication system, but the present application is not limited to these. By not only monitoring the backhaul performance, but by additionally configuring the backhaul performance monitoring, a further improvement in interference avoidance, broadcasting of data, handover, CoMP etc. can be achieved.

For example, in case of CoMP, said wireless communication system comprises a cooperating set of access nodes, said cooperating set is a set of access nodes participating directly or indirectly in said exchange with said user equipment, said cooperating set comprising said first access node, said controlling further comprising at least one of the following: including said second access node in said cooperating set in dependence upon said monitored parameter, operating said second access node included in said cooperating set in dependence upon said monitored parameter, and excluding said second access node from said cooperating set in dependence upon said monitored parameter.

The wireless communication method of the present application, in particular the step of “controlling said exchange of data and/or signalling information between said first and/or second access nodes and said user equipment in dependence upon said monitored parameter” may similarly applied and/or modified to interference co-ordination between access nodes, an handover of UEs, broadcasting of data (such as Multimedia Broadcast and Multicast Services, MBMS) or other scenarios.

The present invention is particularly adapted for use in the context of the LTE-Advanced radio technology as described, for example, in the 36-series (in particular, specification documents 36.xxx and documents related thereto) and releases 8, 9, 10 and subsequent of the 3GPP specification series. However, the present application is not limited to particular specifications, but is adapted for use in the context of all 3GPP LTE and LTE-Advanced specifications and also wireless communication systems of other technologies.

The term “interface” as used in the present application preferably refers to the X2 interface according to specification series 3GPP TS 36.42x. However, the present application also encompasses any other interface that is operable to support the exchange of signalling information (or data and signalling information) between two eNBs, NBs, access nodes and similar entities of a wireless communication system and to, optionally, forward PDUs (Protocol Data Units) to respective endpoints. From a logical standpoint, the interface is a point-to-point interface between two eNBs, NBs, access nodes etc. within the respective network, preferably the E-UTRAN. A point-to-point logical interface is feasible even in the absence of a physical direct connection between the two eNBs, NBs, access nodes etc. That is, the term “interface” refers to a logical connection between eNBs that can be physically routed trough other network nodes.

In one aspect, the present application relates to a wireless communication method in a wireless communication system, said wireless communication system comprising a user equipment and a cooperating set of access nodes, each of the access nodes being operable to wirelessly exchange data and/or signalling information with said user equipment, said cooperating set participating directly or indirectly in said exchange with said user equipment in accordance with an exchange scheme, said cooperating set comprising at least a first access node, said first access node being interconnected by an interface with a second access node, said wireless communication method comprising:
communicating between said first and second access nodes via said interface,
monitoring a communication parameter in accordance with a exchange scheme parameter, wherein said communication parameter relates to said communication between said first and second access nodes via said interface, and wherein said exchange scheme parameter represents said exchange scheme, and
in dependence upon said monitored communication parameter, configuring said cooperating set
by including, operating and/or excluding said second access node in/from said cooperating set, and/or
by changing the exchange scheme.

In another aspect, the present application relates to a wireless communication system comprising:
a user equipment, and
a cooperating set of access nodes,
each of the access nodes being operable to wirelessly exchange data and/or signalling information with said user equipment, said cooperating set participating directly or indirectly in said exchange with said user equipment in accordance with an exchange scheme, and said cooperating set comprising at least a first access node, said first access node being interconnected by an interface with a second access node,
said first and second access nodes being operable to communicate between each other via said interface,
the wireless communication system further comprising
a monitoring unit for monitoring a communication parameter, wherein said communication parameter relates to said communication between said first and second access nodes via said interface, and
a configuring unit for, in dependence upon said monitored communication parameter, configuring said cooperating set
by including, operating and/or excluding said second access node in/from said cooperating set, and/or
by changing the exchange scheme.

In another aspect, the present application relates to an access node operable to be a first access node of a cooperating set of access nodes, each of the access nodes being operable to wirelessly exchange data and/or signalling information with a user equipment, said cooperating set participating directly or indirectly in said exchange with said user equipment in accordance with an exchange scheme, said first access node being interconnected by an interface with a second access node and communicating via said interface with the second access node,
said access node comprising:
a monitoring unit for monitoring a communication parameter, wherein said communication parameter relates to said communication between said first and second access nodes via said interface, and
a configuring unit for, in dependence upon said monitored communication parameter, configuring said cooperating set
by including, operating and/or excluding said second access node in/from said cooperating set, and/or
by changing the exchange scheme.

In another aspect, the present application relates to a user equipment comprising:
an exchange unit for wirelessly exchanging data and/or signalling information with a cooperating set of access nodes,
said cooperating set participating directly or indirectly in said exchange with said user equipment in accordance with an exchange scheme, said cooperating set comprising at least a first access node, said first access node being interconnected by an interface with a second access node and communicating via said interface with the second access node,
said first access node being operable
to monitor a communication parameter, wherein said communication parameter relates to said communication between said first and second access nodes via said interface,
to, in dependence upon said monitored communication parameter, configure said cooperating set by including, operating and/or excluding said second access node in/from said cooperating set, and/or by changing the exchange scheme, and
to transmit configuration information representing the cooperating set configuration to said user equipment,
wherein said user equipment is operable
to receive said configuration information from said first access node, and
to operate the exchange unit in accordance with said received configuration information.

In another aspect, the present application relates to a computer program which, when executed by a processor of an access node in a wireless communication system, carries out the wireless communication method of the present application. In still another aspect, the present application relates to a computer program storing means for storing said computer program.

The present invention is particularly adapted for coordinated multi-point (CoMP) transmission/reception as described, for example, in 3GPP TR 36.814. The disclosure of, in particular section 8 of, this document with regard to the coordinated multi-point (CoMP) transmission/reception is hereby incorporated by reference in the present application. Coordinated multi-point (CoMP) transmission/reception is particularly considered for LTE-Advanced as a tool to improve the coverage of high data rates, the cell-edge throughput and/or to increase system throughput in both high load and low load scenarios. However, the present invention is not limited to the CoMP transmission/reception context of LTE-Advanced, but may be applied in any other wireless communication system using a coordinated multi-point transmission/reception.

Downlink (DL) coordinated multi-point transmission implies dynamic coordination among multiple geographically separated transmission points. A CoMP transmission point(s) (the term “CoMP transmission point” may interchangeably used with the terms “transmission point” and “access node” in the present application, although it is also be possible that one access node comprises a plurality of transmission points) is a point or set of points (the term “set of points” may interchangeably used with the term “a plurality of access nodes” in the present application) actively transmitting PDSCH (Physical Downlink Shared Channel) to UE. A CoMP transmission point(s) is a subset of the CoMP cooperating set (the term “CoMP cooperating set” may interchangeably used with the term “cooperating set” in the present application). A CoMP cooperating set is a set of (preferably geographically separated) points directly or indirectly participating in PDSCH transmission to UE. A serving cell (the term “serving cell” refers to a radio network object that can be uniquely identified by a UE from a cell identification that is broadcast over a geographical area from one access node) is a, preferably single, cell transmitting PDCCH (Physical Downlink Control Channel) assignments.

In downlink coordinated multi-point transmission, there are different CoMP methods (also referred to as “exchange schemes” in the present application):
Joint Processing (JP), where data is available at each point in a CoMP cooperating set. Particular sub-modes of the JP are the
   Joint Transmission (JT), where PDSCH transmission is carried out from multiple points (part of or entire CoMP cooperating set) at a time. Data to a single UE is simultaneously transmitted from multiple transmission points, e.g. to (coherently or non-coherently) improve the received signal quality and/or cancel actively interference for other UEs. For Joint transmission, the CoMP transmission points are the points in the CoMP cooperating set.
   Dynamic cell selection (DSC), where PDSCH transmission is carried out from one point at a time (within CoMP cooperating set). For Dynamic cell selection, a single point is the transmission point at preferably every subframe. This transmission point may change dynamically within the CoMP cooperating set.
Coordinated Scheduling/Beamforming (CS/CB), where data is only available at the serving cell (data transmission from that point), but user scheduling/beamforming decisions are made with coordination among cells corresponding to the CoMP cooperating set. For Coordinated scheduling/beamforming, the CoMP transmission point corresponds to the serving cell.

In addition to the CoMP cooperating set, there may also be present a CoMP measurement set. The CoMP measurement set is a set of cells about which channel state/statistical information related to their link to the UE is reported as, for example, discussed in section 8.1.3 of 3GPP TR 36.814. The CoMP measurement set may be the same as the CoMP cooperating set.

The disclosure of sections 8.1.2, 8.1.3 and 8.1.4 of 3GPP TR 36.814 with regard to radio-interface specification areas, feedback in support of DL CoMP, and overhead in support of DL CoMP operation is hereby incorporated by reference in the present application.

Uplink (UL) coordinated multi-point reception implies coordination among multiple, geographically separated points. Uplink CoMP reception may involve joint reception (JR) of the transmitted signal at multiple reception points (preferably analogously implemented as explained above with respect to JP in the downlink) and/or coordinated scheduling (CS) decisions among cells to control interference (preferably analogously implemented as explained above with respect to CS in the downlink).

Thus, in some CoMP schemes, not all co-operating access nodes necessarily exchange data with the user equipment. For example, the co-operating access nodes may coordinate the exchange to avoid causing interference to the wireless communication links actually carrying data exchanges. Thus, the step of “said cooperating set participating directly or indirectly in said exchange with said user equipment” may refer to “exchanging data or facilitating the exchange of data with said user equipment”.

The inventors of the present application realized that there are specific X2 requirements for Inter-eNB CoMP. That is, the basic X2 requirements for different inter-eNB CoMP schemes may be different. For example, the X2 bandwidth requirement for DL CS/CB may be lower than that for DL Joint Processing as data is available at each point in a CoMP cooperating set in DL Joint Processing whereas data is only available at the serving cell in DL CS/CB.

Basically, all the inter-eNB CoMP schemes tend to be sensitive to latency, while the DL JP schemes have higher demand on bandwidth compared with the DL CS/CB and UL CoMP schemes.

The inventors further realized that use of the inter-eNB CoMP schemes may be impacted by the X2 backhaul performance. The inventors further found that the X2 performance, especially latency, is highly deployment dependent, such as on, for example, whether there is a dedicated X2 fibre network or a generic IP network. The performance of the X2 interfaces changes over time and network conditions and the performance of CoMP is dependent not only on the radio channel conditions with the UE but also the backhaul links between the cooperating access nodes.

Thus, the inventors propose in a preferred embodiment of the present invention a CoMP control and management mechanism with X2 backhaul performance monitoring of a communication parameter of said X2 backhaul. In addition, a measurement configuration parameter is proposed in order to configure the monitoring of the performance of X2 interface between two eNodeBs. Further options for X2 measurement and reporting are also proposed, which preferably provide alternatives for information sharing among eNodeBs via a defined interface in a 3GPP LTE network. Thus, the present invention addresses backhaul, especially X2 interface, performance considerations in order to decide and manage a CoMP cooperating set and, optionally, the CoMP measurement set.

The present invention thus proposes in a preferred embodiment a method to automatically and dynamically control the formulation of a CoMP set for a given UE connection based not only on the radio (Uu) but also the inter-eNodeB network (X2 link) performance. The traffic loading of X2 link between different pairs of eNodeBs may be different and vary differently with time. Embodiments of the present invention propose that adding new CoMP traffic on a given X2 link to successfully support the CoMP connection depends on the X2 performance at the time. As such, embodiments of the invention specifically refer to criteria and trigger mechanisms for a neighbouring access node to dynamically enter and exit the available pool of CoMP supporting neighbour cells.

Embodiments of the present invention further enable early deployment of CoMP without needing all of the inter-eNodeB links to be upgraded or needing to have same capacity. This in turn offers greater flexibility in cost-effective network roll-out and enable improved network performance due to CoMP from the available network resources.

According to embodiments of the present invention, the choice of CoMP scheme (also referred as “exchange scheme”) is dependant upon the results of the monitoring (preferably measurements) made on the X2 interface. For example if the measurements indicate that the X2 interface has a poor (high) latency, then only a subset of possible CoMP schemes may be deployed, such as Co-ordinated Beam-forming, to mitigate interference, whereas if the link has a good (low) latency, then more demanding CoMP schemes, such as Joint Transmission, may also be used.

Embodiments of the present invention enable deployment of CoMP in an evolving radio access network with inter-eNodeB links having differing performance. This alleviates the need for on-going re-configuration of radio network set-up determining which cells can support CoMP mode as the access network and traffic patterns evolve over time. Embodiments of the present invention offer an automated solution for a dynamic control and configuration of the CoMP operation, reducing network engineering labour costs.

Embodiments of the present invention also enable early deployment of CoMP without needing all of the inter-eNodeB links to be upgraded or needing to have the same capacity and performance. This in turn offers greater flexibility in cost-effective network roll-out and enable improved network performance due to CoMP from the available network resources.

It is noted that the UE used in a wireless communication system of the present invention may be the same or different from a conventional user equipment depending on the details of the exact CoMP scheme used and or supporting radio measurements that the UE preferably makes to support the CoMP scheme controlling.

In a preferred embodiment, said monitoring comprises: monitoring said communication parameter in accordance with an exchange scheme parameter designating said exchange scheme. Accordingly, the configuration of the X2 monitoring (preferably measuring) depends on the CoMP scheme. For different CoMP schemes, different configurations of the monitoring may be required. For example, in the case of CoMP using joint processing, low latency may required on the X2 interface, so measurements that support this would need to be configured. Embodiments of the present invention thus provide an efficient solution for selecting, monitoring and managing CoMP operations. Embodiments propose a reduction in the amount of backhaul performance and UEs measurements that would possibly have to be performed for the control and management mechanism for CoMP operations. According to this preferred embodiment, only measurements are performed which are determined to be required on basis of the cooperating set of access nodes and/or identified by information from the UEs measurement reports and the backhaul performance measurement reports. The X2 backhaul performance may thus be monitored by measuring some critical parameters based on the requirements of the CoMP scheme(s) and the performance of the UE's application(s).

In a preferred embodiment, said monitoring comprises: measuring said communication parameter at the first and/or second access node, and reporting said measured communication parameter within/to the first access node. That is, a measurement result (also referred to as “measured communication parameter”) may be reported within an access node or to (one or more) peer access nodes.

In a preferred embodiment, said measuring comprises: measuring said communication parameter at the first and/or second access node in accordance with a measurement configuration parameter, said measurement configuration parameter representing a configuration of said measuring. Preferably said measurement configuration parameter is associated with an exchange scheme. Thus, the measuring may be adapted to the specific requirement of an exchange scheme which is presently used or which is considered to be used. For an particularly efficient X2 performance measuring and reporting, it is thus proposed that the first access node, e.g. the serving eNB, can configure the cooperating eNB(s) with the parameters for the X2 backhaul measurement and reporting.

In a preferred embodiment, said wireless communication method further comprises: transmitting the measurement configuration parameter from the first access node to the second access node, measuring said communication parameter at the second access node in accordance with said measurement configuration parameter, and reporting a measurement report including said measured communication parameter from the second access node to the first access node.

In a preferred embodiment, said measurement configuration parameter designates at least one of the following: a measurement object to be measured on, a reporting configuration, and a measurement timing gap.

In a preferred embodiment, said transmitting is part of a signalling information protocol, which is preferably carried out at a setup of said interface and/or as a configuration update of said interface.

In a preferred embodiment, said reporting is part of a signalling information protocol.

In a preferred embodiment, said reporting comprises: reporting said measured communication parameter on a sub-stream of said interface. Accordingly, X2 measurement reporting may be activated in specific bearers being part of the whole X2 link. Such bearers may relate to different system scenarios (e.g. interference co-ordination, CoMP (e.g. joint transmission), broadcasting of data or handover), and have different QoS requirements.

In a preferred embodiment, said reporting comprises: determining whether a value of said measured communication parameter exceeds a threshold value, reporting said measured communication parameter, if said value of said measured communication parameter exceeds said threshold value, or stopping reporting said measured communication parameter, if said value of said measured communication parameter exceeds said threshold value. Similarly, in another preferred embodiment, said reporting comprises: determining whether a value of said measured communication parameter is less than a threshold value, reporting said measured communication parameter, if said value of said measured communication parameter is less than said threshold value, or stopping reporting said measured communication parameter, if said value of said measured communication parameter is less than said threshold value. In a further preferred embodiment, both steps of reporting and stopping reporting are comprised in the wireless communication method, and the thresholds for initiating the reporting and stopping the reporting are different. Thus, the measurement reports may be transmitted on a conditional basis. The conditional transmission of measurement reports is, for example, based on a load level exceeding a certain threshold or latency exceeding a certain threshold or some combination of the two or more measures. In using thresholds for setting a condition for measurement reporting, start and stop reporting thresholds are preferably different, thus introducing hysteresis to prevent instability. In preferred embodiments, the threshold may be configured by a semi-static configuration, for example RRC (Radio Resource Control) configuration, which is preferably fixed in respective wireless communication specifications.

In a preferred embodiment, said wireless communication method further comprises at least one of the following: initiating a measurement reporting mode for measuring said communication parameter and reporting the measured communication parameter, if said second access node is comprised in the cooperating set, and exiting said measurement reporting mode for measuring said communication parameter and reporting the measured communication parameter, if said second access node is not comprised in the cooperating set. Thus, the X2-link performance measurements may be activated and deactivated. However, it may also be the case that the measurements are permanently carried out.

Accordingly, the present invention specifically refers to how (and where) measurements are reported and to the configuration of such measurement reporting.

In a preferred embodiment, said wireless communication method further comprises: communicating between said first and a plurality of further access nodes via a plurality of interfaces, determining a set of relevant interfaces among said plurality of interfaces, monitoring a plurality of communication parameters, wherein said plurality of communication parameters relates to said communications via said set of relevant interfaces. The X2 measurement reporting may be activated in all relevant X2 interfaces whenever one or more CoMP schemes are activated in a network or a part of the network. The relevant links (also referred to as “relevant interfaces”) may be pre-selected or pre-set by a network management system or by some “smart criteria”. For example, the pre-selection may be preferred if capacity/latency problems are known or anticipated in a specific X2 interface, for example due to limited available bandwidth. The smart criteria may defined by network algorithms which examine the recent performance history and choose to include or exclude X2 links in a pre-set of this pre-selection.

In a preferred embodiment, said exchange scheme is one of the following:

a first exchange scheme comprising the steps of: forwarding data from said first access node to said second access node, and transmitting said data from said first and/or second access nodes to said user equipment;
a second exchange scheme comprising the steps of: forwarding signalling information from said first access node to said second access node, and transmitting data from said first access node to said user equipment; and
a third exchange scheme comprising the steps of: receiving data and/or signalling information from said user equipment at said second access node, and forwarding said received data and/or signalling information from said second access node to said first access node via said interface.

The first exchange scheme is preferably the DL Inter-eNB JP. The second exchange scheme is preferably the DL Inter-eNB CS/CB. The third exchange scheme is preferably the UL Inter-eNB CoMP. However, the present invention is not limited to these three exchange schemes. Further exchange schemes may be used in connection with the present invention.

In a preferred embodiment, said communication parameter represents at least one of the following: a latency of said interface, and a bandwidth of said interface. It may also be preferred that said communication parameter represents at least one of the following: an availability of the interface (for example, a measurement of the percentage of uptime in a given time period), a reliability of the interface (for example, a statistical average of other parameters), a probability of packet loss when communicating over the interface, a round trip time when communicating over the interface (for example, a ping), a directional latency of the interface (time for packet to travel from access node (a) to access node (b) and also access node (b) to access node (a), a data rate when communicating over the interface (peak and/or averaged).

It is noted, that any combination of the aspects and embodiments as described in the present application is comprised in the scope of the present application. Also, the present invention is not limited to LTE-Advanced, but may preferably be applied in all wired and wireless communications systems where relaying techniques over an interface between access nodes are used.

Thus, particularly preferred embodiments of the present invention relate to a selection of eNodeBs for a CoMP set dependent on relevant radio and X2-link performance measures, a method and associated signalling for X2-link performance measurements and reporting, and a method and criteria for activation and deactivation of X2-link performance measures.

Preferred embodiments of the present application will now be described, by way of example, with reference to the accompanying drawings in which,

FIG. 1 illustrates a LTE Network Architecture,

FIG. 2 illustrates a Control Plane and a User Plane Protocol Architecture,

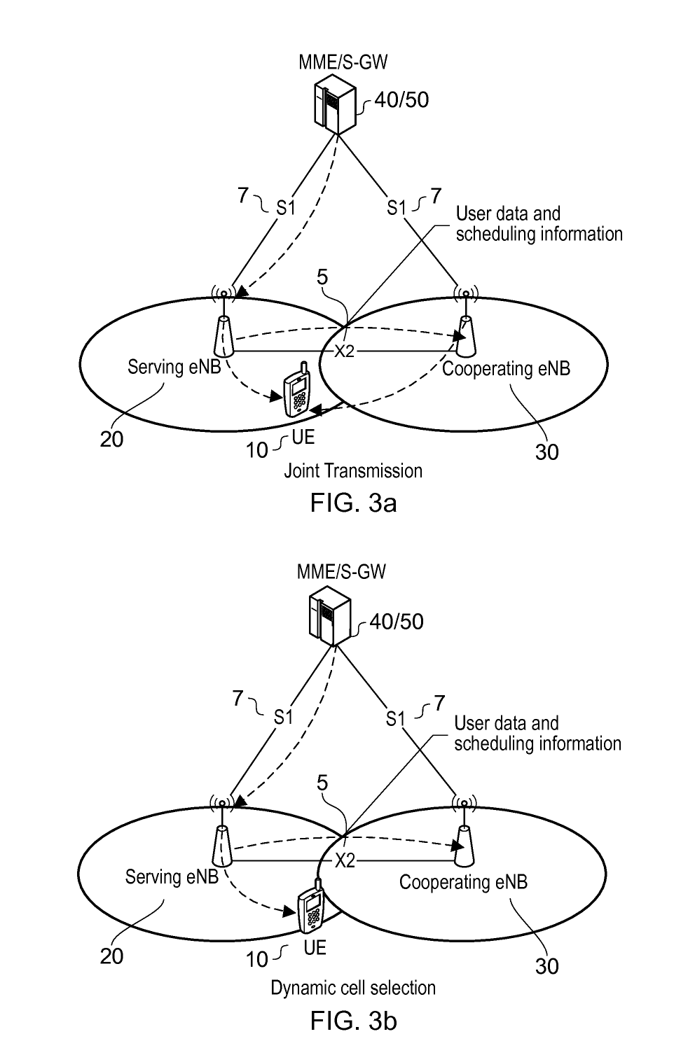

FIGS. 3a and 3b illustrate Downlink Inter-eNB Joint Processing,

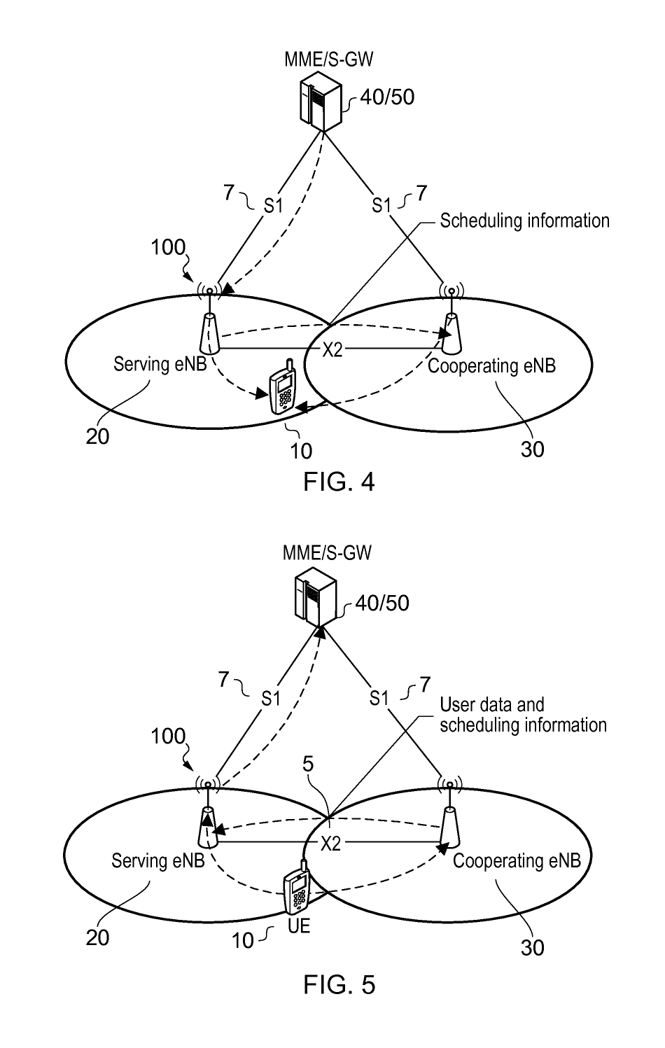

FIG. 4 illustrates Downlink Inter-eNB CS/CB,

FIG. 5 illustrates Uplink Inter-eNB CoMP,

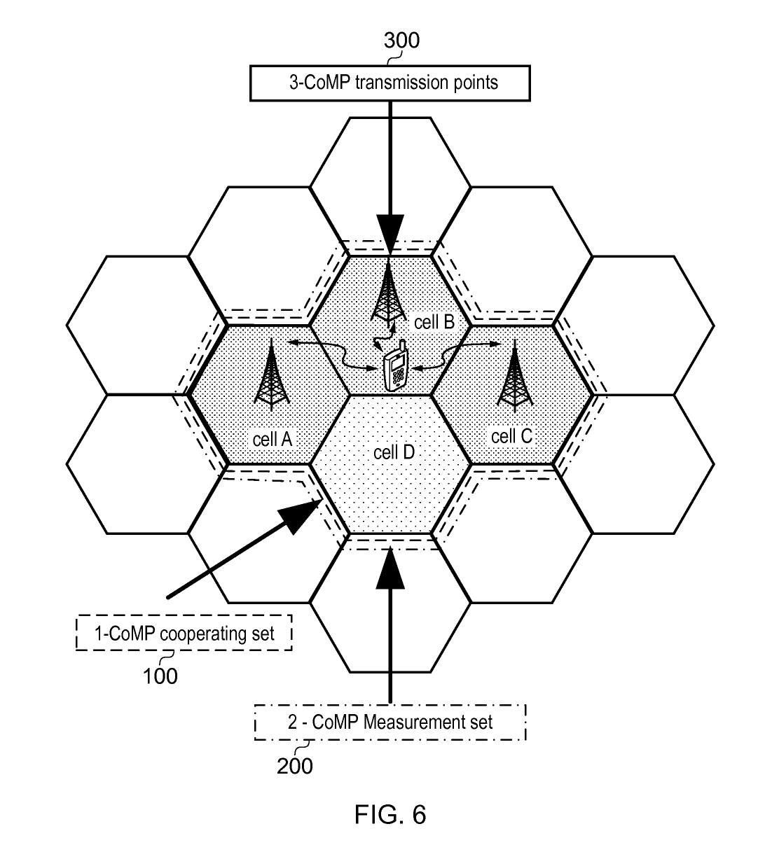

FIG. 6 illustrates CoMP cooperating and measurement sets in the case of Joint Processing,

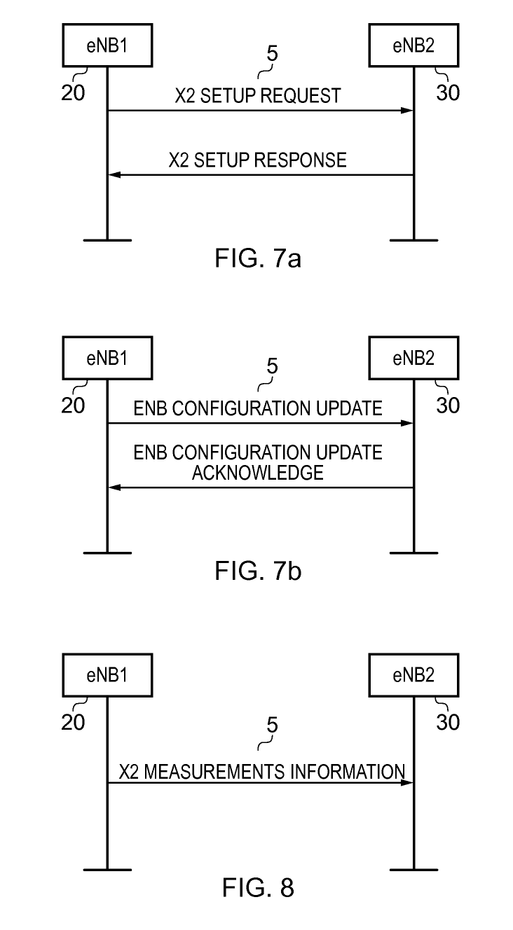

FIGS. 7a and 7b illustrate X2 Setup and eNB Configuration Update,

FIG. 8 illustrates a X2 Measurement Report,

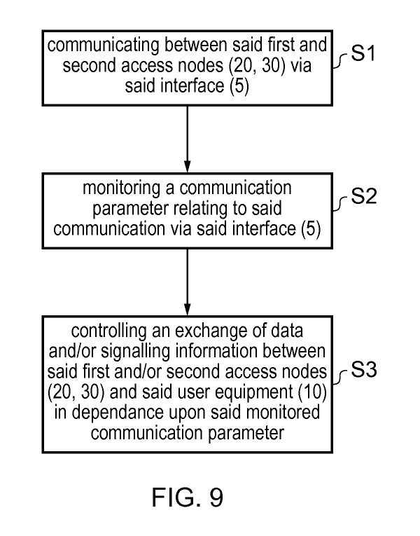

FIG. 9 illustrates a flowchart of a first embodiment of the present invention, and

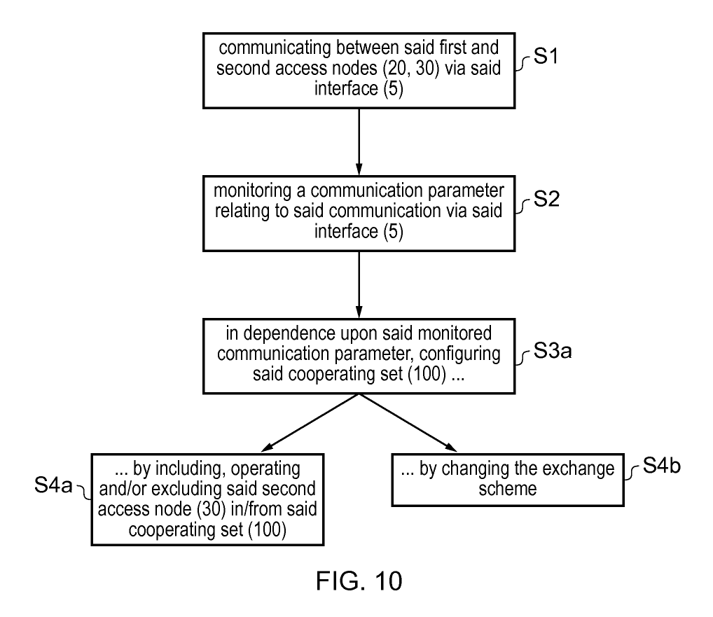

FIG. 10 illustrates a flowchart of a second embodiment of the present invention.

FIGS. 3 to 5 illustrate preferred exchange schemes of the present invention.

The DL Inter-eNB JP can improve the coverage of high data rates, the cell-edge and/or system throughput. For UEs at the cell edge, it can also improve the user experience during handover. In the DL Inter-eNB JP exchange schemes, the DL data to a single UE 10 is available at each transmission point (or access node) 20, 30 in CoMP cooperating set 100. These transmission points are in different eNBs 20, 30, and the user data is transmitted from the serving eNB 20 to the cooperating eNB(s) 30 via X2 interface 5.

FIGS. 3a and 3b illustrate two types of DL inter-eNB JP exchange schemes: (1) joint transmission (FIG. 3a), where the data to a single UE 10 is simultaneously transmitted from multiple transmission points 20, 30; and (2) dynamic cell selection (FIG. 3b), where the data is transmitted from one transmission point at a time. In both cases, the user data and the scheduling information are transferred from the serving eNB 20 to the cooperating eNB(s) 30.

The DL Inter-eNB Coordinated Scheduling/Beamforming (CS/CB) exchange scheme can decrease the interference and increase the system throughput. In this exchange scheme illustrated in FIG. 4, user data is only available at the serving cell 20 (data transmission from that access node). However, the scheduling information and channel information/feed-back are exchanged over X2 interface 5 between the serving eNB 20 and the cooperating eNB(s) 30.

For Uplink inter-eNB CoMP illustrated in FIG. 5, when coordinated reception points (an access node may comprise one or more reception points) are in different eNBs 20, 30, the scheduling information and the received data packets are transmitted over X2 interface 5. If the cooperating eNBs 30 forward all the CoMP UE's data to the serving eNB 20, the amount of the forwarded data over the X2 interface 5 will be similar to the DL inter-eNB JP. However, the forwarded data may be reduced significantly in an uplink scenario by introducing some policies, e.g. the cooperating eNB 30 may only forward the packets to the serving eNB 20 upon request in case of an unsuccessful HARQ procedure.

Based on the definitions specified in 3GPP TR 36.814, FIG. 6 shows the CoMP cooperating set, CoMP measurement set and CoMP transmission points in the case of CoMP JP.

In FIG. 6, cell B is the serving cell 20 and the CoMP cooperating set 100 includes cells A, B, C and D, in which only cells A, B and C are the CoMP transmission points. Cell D is not used as part of the CoMP cooperating set 100 of cells using CoMP for the UE.

The CoMP measurement set 200 includes cells A, B, C and D, for which the UE will make and report pre-defined measurements to serving cell B. These measurements may mainly refer to the radio channel state/statistical information related to the radio links to the UE.

As discussed before, in the case of an inter-eNB CoMP exchange scheme scenario, the performance of the X2 backhaul is preferably used in order to decide the CoMP cooperating set. In a preferred embodiment of the present invention it is proposed to dynamically control and manage the selection of a CoMP set based not only on the performance of radio links but also on the X2 backhaul performance.

In the embodiment illustrated in FIG. 6, a UE is already in connected mode with serving cell B. Based on the radio channel conditions reported by the UE, the serving cell B determines if the radio channel conditions are such that the activation of CoMP should be considered. When the network (preferably the serving eNodeB that controls the serving cell) decides to consider CoMP, the serving eNodeB will trigger the UE to monitor, preferably to perform measurements, of neighbour cells using a list of candidate cells. The candidate CoMP cells may be signalled by the serving eNodeB by means of a system broadcast message or by means of dedicated signalling to specific UE(s). UE reports to the serving eNodeB the radio channel measurements of all CoMP suitable cells. The serving eNodeB may have a continuously updated knowledge of performance of individual X2-links with the neighbour eNodeBs or may activate performance measurements on all relevant X2-links. The decision to activate CoMP mode for the UE is taken by the serving eNodeB based on both the radio channel measurements and an associated X2-link having adequate performances. If the serving eNodeB activates CoMP, said associated X2-link is included to the CoMP cooperating set.

In this embodiment, it is assumed that the CoMP mode is activated from the connected mode. However, the UE may set-up the connection with the serving eNodeB also after the CoMP mode is activated.

In the following paragraphs, preferred embodiments of procedures and mechanisms for reducing the measurement and processing overhead arising from the measurements si described.

The X2 backhaul performance may be monitored by measuring some critical parameters based on the requirements of the CoMP scheme(s) and the UE's application(s). These measurements parameters at least include latency and bandwidth.

The latency of the X2 backhaul refers to the time taken for an X2-AP packet to be transmitted and processed from the source eNB to the target eNB. The X2 backhaul latency between two eNBs can be monitored via measuring the end-to-end delay at the X2-AP layer, which consists of transmission delay, propagation delay and processing delay.

The bandwidth of the X2 backhaul is monitored via a throughput measurement of the X2 communication between two eNBs. The maximum throughput, which is essentially synonymous to digital bandwidth capacity, can be derived from:

Max. Throughput=SCTP Window Size/Round-trip time

where, SCTP Window Size is defined when the SCTP association is initiated between two eNodeBs, and the round-trip time is determined by the end-to-end delay.

For efficient X2 performance monitoring and reporting, it is proposed in a preferred embodiment of the present invention that the eNB, e.g. the serving eNB, can configure the cooperating eNB(s) with the parameters for the X2 backhaul measurement and reporting. The measurement configuration parameters include, for example:

a) Measurement objects. A measurement object defines on what the eNodeB should perform the measurements, such as end-to-end delay. The measurement object may include a list of target eNodeBs to be considered as well as associated parameters, e.g. end-to-end delay or throughput.
b) Reporting configuration. A reporting configuration consists of the (periodic or event-triggered) criteria which cause the eNodeB to send a measurement report, as well as the details of what information the eNodeB is expected to report (e.g. end-to-end one way latency, or end-to-end round trip time, etc.).
c) Measurement timing gaps. Measurement timing gaps define time periods the eNodeB may perform the measurement.

The two preferred ways of reporting X2 backhaul performance are:

1) Measurement reporting within an eNodeB. Within an eNodeB, the transport layer protocols report the measurements to X2 AP layer via the internal interface. The measurements information is not shared among eNodeBs.
2) Measurement reporting to the peer eNodeBs. The eNodeBs with X2 interfaces in between exchange/share the measurements through X2 signalling. X2 measurements information sharing may be particularly relevant in the case that X2 connections between two eNodeBs perform differently in two directions (from eNodeB1 to eNodeB2, and from eNodeB2 to eNodeB1). In this case, the measurement configuration information can be initiated between two peer eNodeBs via, for example, X2 Setup procedure and updated via eNB Configuration Update procedure as illustrated in FIGS. 7a and 7b. However, other procedures may be used as well for this purpose, for example the procedures as specified in section 8 of 3GPP TS 36.423, the disclosure thereof is herewith incorporated by reference into the present application.

There are two preferred ways of measurement reporting to the peer eNodeBs:

2.i) New X2-AP signalling for X2 measurements report. The X2 Measurement Report procedure illustrated in FIG. 8 refers to transfer X2 measurements information between eNBs. The procedure uses non UE-associated signalling.
2.ii) Piggyback via existing X2-AP signalling. Alternatively to said new X2-AP signalling for X2 measurements report, existing X2-AP signalling messages can be used to piggyback the X2 measurements information.

In the following, preferred embodiment for activation and deactivation of X2 backhaul performance measurements reporting are described:

The X2 measurements are preferably activated in all relevant X2 links whenever the CoMP features are activated in a network or a part of the network. The relevant X2 links can be all links in the whole or part of the network where CoMP feature is activated. The relevant links may be pre-selected or pre-set by Network Management system or by some “smart criteria”. For example, the pre-selection may be preferred for the case when capacity/latency problems are known or anticipated in specific X2 links, for example, due to limited available bandwidth. The smart criteria may be network algorithms which examine the recent performance history and choose to include or exclude X2 links in this pre-set or pre-selection.

Similarly, the X2 measurements may be deactivated in all relevant X2 links whenever the CoMP features are de-activated in a network or part of the network.

When X2 measurements are activated, the eNBs preferably share the measurements on time periodic basis or on time aperiodic basis (for example, event based, in accordance with a minimum change level etc).

Furthermore, the reports (periodic or aperiodic) may be transmitted on conditional or non-conditional basis. The conditional transmission of reports may, for example, be based on a load level exceeding a certain threshold or latency exceeding a certain threshold or some combination of the two or more measures. In cases where thresholds are applied, start and stop reporting thresholds are preferably different, thus introducing hysteresis to prevent instability. The configuration of these thresholds may be determined by thresholds written in fixed specifications for being configured by a semi-static configuration, for example RRC configuration.

The above activating and deactivating procedures may be applied to any other feature that is dependent on the X2 link performance.

FIG. 9 illustrates a flowchart of a first embodiment of a wireless communication method according to the present invention. A wireless communication system using the method as illustrated in FIG. 9 comprises a plurality of access nodes and a user equipment. Each of the access nodes is operable to wirelessly exchange data and/or signalling information with the user equipment. Said plurality of access nodes comprises at least a first access node and a second access node. Said first and second access nodes are interconnected by an interface.

The wireless communication method as illustrated in FIG. 9 comprises the following steps: in step S1, communicating between said first and second access nodes via said interface; in step S2, monitoring a parameter relating to said communication between said first and second access nodes via said interface, and in step S3, controlling said exchange of data and/or signalling information between said first and/or second access nodes and said user equipment in dependence upon said monitored parameter.

FIG. 10 illustrates a flowchart of a second embodiment of a wireless communication method for CoMP according to the present invention. A wireless communication system using the method as illustrated in FIG. 10 comprises a user equipment and a cooperating set of access nodes. Each of the access nodes is operable to wirelessly exchange data and/or signalling information with said user equipment. Said cooperating set participates directly or indirectly in said exchange with said user equipment in accordance with an exchange scheme. Said cooperating set comprises at least a first access node. Said first access node is interconnected by an interface with a second access node.

The wireless communication method as illustrated in FIG. 10 comprises the following steps: in step S1, communicating between said first and second access nodes via said interface, in step S2, monitoring a communication parameter, wherein said communication parameter relates to said communication between said first and second access nodes via said interface, and, in dependence upon said monitored communication parameter, in step S3a, configuring said cooperating set: by, in step S4a, including, operating and/or excluding said second access node in/from said cooperating set, and/or, by, in step S4b, changing the exchange scheme.

Thus, step S3 of the first embodiment is be adapted to the specific scenario of CoMP in the second embodiment. That is, step S3 comprises steps 3a, 4a, and 4b. Similarly, step S3 may be adapted to other scenarios, such as interference-coordination, broadcasting of data or handover in other embodiments of the present invention.

1. A wireless communication method in a wireless communication system, said wireless communication system comprising a user equipment and a cooperating set of access nodes, each of the access nodes being operable to wirelessly exchange data and/or signalling information with said user equipment, said cooperating set participating directly or indirectly in said exchange with said user equipment in accordance with an exchange scheme, said cooperating set comprising at least a first access node, said first access node being interconnected by an interface with a second access node, said wireless communication method comprising:
communicating (S1) between said first and second access nodes via said interface,
monitoring (S2) a communication parameter, wherein said communication parameter relates to said communication between said first and second access nodes via said interface, and
in dependence upon said monitored communication parameter, configuring (S3a) said cooperating set by including, operating and/or excluding (S4a) said second access node in/from said cooperating set, and/or by changing (S4b) the exchange scheme.

2. Wireless communication method according to claim 1, wherein said monitoring comprises:
monitoring said communication parameter in accordance with an exchange scheme parameter designating said exchange scheme.

3. Wireless communication method according to claim 1, wherein said monitoring comprises:
measuring said communication parameter at the first and/or second access node, and
reporting said measured communication parameter within/to the first access node.

4. Wireless communication method according to claim 3, wherein said measuring comprises:
measuring said communication parameter at the first and/or second access node in accordance with a measurement configuration parameter, said measurement configuration parameter representing a configuration of said measuring.

5. Wireless communication method according to claim 4, further comprising:
transmitting the measurement configuration parameter from the first access node to the second access node,
measuring said communication parameter at the second access node in accordance with said measurement configuration parameter, and
reporting a measurement report including said measured communication parameter from the second access node to the first access node.

6. Wireless communication method according to claim 5, wherein said transmitting is part of a signalling information protocol, which is preferably carried out at a setup of said interface and/or as a configuration update of said interface.

7. Wireless communication method according to claim 3, wherein said reporting is part of a signalling information protocol.

8. Wireless communication method according to claim 3, wherein said reporting comprises:
reporting said measured communication parameter on a sub-stream of said interface.

9. Wireless communication method according to claim 3, wherein said reporting comprises:
determining whether a value of said measured communication parameter exceeds a threshold value,
reporting said measured communication parameter, if said value of said measured communication parameter exceeds said threshold value, or stopping reporting said measured communication parameter, if said value of said measured communication parameter exceeds said threshold value.

10. Wireless communication method according to claim 3, said wireless communication method further comprising at least one of the following:
initiating a measurement reporting mode for measuring said communication parameter and reporting the measured communication parameter, if said second access node is comprised in the cooperating set, and
exiting said measurement reporting mode for measuring said communication parameter and reporting the measured communication parameter, if said second access node is not comprised in the cooperating set.

11. Wireless communication method according to claim 1, further comprising:
communicating between said first access node and a plurality of further access nodes via a plurality of interfaces,
determining a set of relevant interfaces among said plurality of interfaces,
monitoring a plurality of communication parameters, wherein said plurality of communication parameters relates to said communications via said set of relevant interfaces.

12. A wireless communication system comprising:
a user equipment, and
a cooperating set of access nodes,
each of the access nodes being operable to wirelessly exchange data and/or signalling information with said user equipment, said cooperating set participating directly or indirectly in said exchange with said user equipment in accordance with an exchange scheme, and said cooperating set comprising at least a first access node, said first access node being interconnected by an interface with a second access node,
said first and second access nodes being operable to communicate between each other via said interface,
the wireless communication system further comprising
a monitoring unit for monitoring a communication parameter, wherein said communication parameter relates to said communication between said first and second access nodes via said interface, and
a configuring unit for, in dependence upon said monitored communication parameter, configuring said cooperating set
by including, operating and/or excluding said second access node in/from said cooperating set, and/or
by changing the exchange scheme.

13. An access node operable to be a first access node of a cooperating set of access nodes, each of the access nodes being operable to wirelessly exchange data and/or signalling information with a user equipment, said cooperating set participating directly or indirectly in said exchange with said user equipment in accordance with an exchange scheme, said first access node being interconnected by an interface with a second access node and communicating via said interface with the second access node,
said access node comprising:
a monitoring unit for monitoring a communication parameter, wherein said communication parameter relates to said communication between said first and second access nodes via said interface, and
a configuring unit for, in dependence upon said monitored communication parameter, configuring said cooperating set
by including, operating and/or excluding said second access node in/from said cooperating set, and/or
by changing the exchange scheme.

14. A user equipment comprising:
an exchange unit for wirelessly exchanging data and/or signalling information with a cooperating set of access nodes,
said cooperating set participating directly or indirectly in said exchange with said user equipment in accordance with an exchange scheme, said cooperating set comprising at least a first access node, said first access node being interconnected by an interface with a second access node and communicating via said interface with the second access node,
said first access node being operable
to monitor a communication parameter, wherein said communication parameter relates to said communication between said first and second access nodes via said interface,
to, in dependence upon said monitored communication parameter, configure said cooperating set by including, operating and/or excluding said second access node in/from said cooperating set, and/or by changing the exchange scheme, and
to transmit configuration information representing the cooperating set configuration to said user equipment,
wherein said user equipment is operable
to receive said configuration information from said first access node, and
to operate the exchange unit in accordance with said received configuration information.

15. A computer program which, when executed by a processor of an access node in a wireless communication system, carries out the wireless communication method of a claim 1.
